(19) United States
(12) Patent Application Publication
(10) Pub. No.: US 2004/0041466 A1
(43) Pub. Date: Mar. 4, 2004

(54) Actuating travel simulator for a vehicle actuating unit

(76) Inventor: Bernhard Giers, Frankfurt (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/381,495

(22) PCT Filed: Sep. 26, 2001
(86) PCT No.: PCT/EP01/11163

(30) Foreign Application Priority Data
Sep. 27, 2000 (DE) 100 49 094.8
Oct. 31, 2000 (DE) 100 53 994.7

(51) Int. Cl. B60T 13/66

(52) U.S. Cl. 303/20; 303/9

(57) ABSTRACT

The present invention relates to an actuating travel simulator for a vehicle actuating unit, preferably a brake pedal, which simulator includes a hydraulic simulator piston in a hydraulic simulator chamber containing a hydraulic fluid, said simulator being characterized in that the simulator chamber includes at least one opening through which fluid is discharged from or supplied to the simulator chamber when the vehicle actuating unit is actuated, and that an adjusting means is provided to control the fluid volume discharged from the simulator chamber and/or supplied to the simulator chamber in such a way that a defined force-travel characteristic curve of the actuating unit is produced.

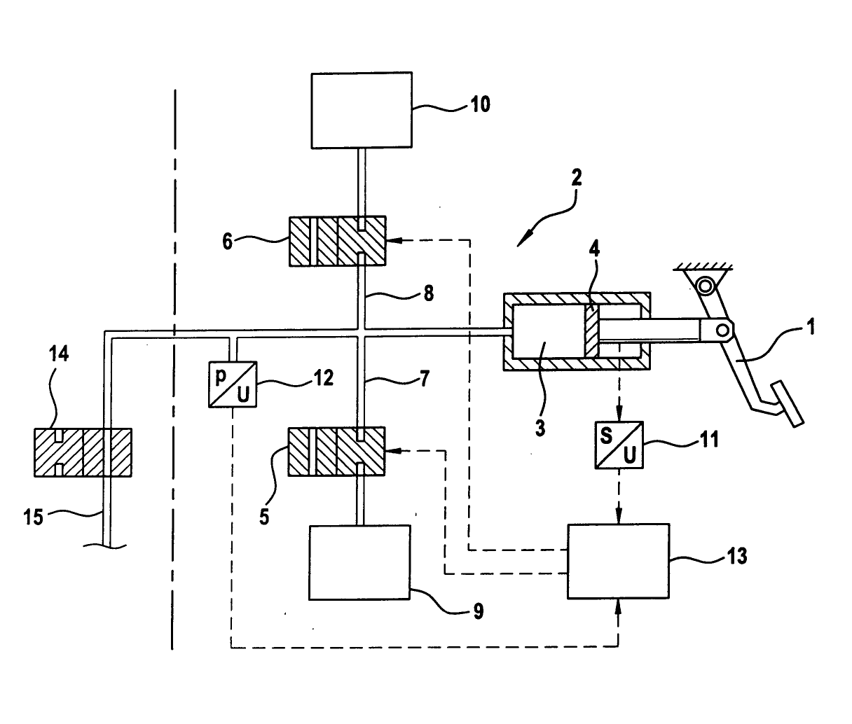

### TECHNICAL FIELD

The present invention generally relates to vehicle controls, and more particularly relates to an actuating travel simulator for a vehicle actuating unit.

### BACKGROUND OF THE INVENTION

Mechanical or mechanical/hydraulic actuating travel simulators for vehicle actuating units, hereinbelow briefly called ‘simulators’ are e.g. known in vehicle brake systems. With these simulators the brake force applied by the driver acts on a simulator piston that is supported on an elastic means, e.g. a steel spring. Thus, the correlation between pedal travel and generated force being known from customary hydraulic brake systems is reproduced in a mechanical way.

Actuating travel simulators of this type are employed in brake-by-wire vehicle brake systems such as an electro-hydraulic brake (EHB) or an electromechanical brake (EMB) wherein the brake pedal is uncoupled from the wheel brakes in the normal braking operation, the driver's braking wish is detected by means of sensors and sent to an electronic unit controlling the pressurization of the individual wheel brakes. The energy for the braking pressure is supplied by an independent energy source, and hydraulic actuators (EHB) or electromechanical actuators (EMB) produce the braking pressure. The pedal feeling to which the driver is used, is produced by actuating travel simulators, which impart to the driver a pedal feeling that is basically unchanged compared to conventional hydraulic brake systems.

### BRIEF SUMMARY OF THE INVENTION

An object of the present invention is to provide an actuating travel simulator and a method for the simulation of a defined actuating travel characteristic curve.

According to the present invention, this object is achieved in that in an actuating travel simulator for a vehicle actuating unit, preferably a brake pedal, which simulator includes a hydraulic simulator piston in a hydraulic simulator chamber containing a hydraulic fluid, said simulator chamber includes at least one opening through which fluid is discharged from or supplied to the simulator chamber when the vehicle actuating unit is actuated, and that an adjusting means is provided to control the fluid volume discharged from the simulator chamber and/or supplied to the simulator chamber in such a way that a defined force-travel characteristic curve of the actuating unit is produced.

An additional provision is that the actuating travel simulator can be used as a hydraulic emergency pressure generator in a case of emergency (failure of an electronic brake control or current failure).

The term ‘simulator piston’ herein does not necessarily mean a piston employed in known systems and serving to separate media. The simulator piston of the present invention in its capacity as a hydraulic piston rather effects directly a change of the fluid volume in the simulator chamber.

It is arranged for that associated with the actuating travel simulator is a preferably non-pressurized supply reservoir for the hydraulic fluid, said reservoir being connected to the simulator chamber by way of a first hydraulic line in which a first adjusting means, preferably a first valve, is arranged.

According to the present invention, a pressure source for the hydraulic fluid, preferably a high-pressure accumulator, is associated with the actuating travel simulator, said pressure source being connected to the simulator chamber by way of a second hydraulic line in which a second adjusting means, preferably a second valve, is arranged.

A normally closed (NC) valve is preferably the first and/or the second valve. Analog valves, analogized on/off valves, or switching valves, especially three-way/two-position directional control valves, can be employed, but analog valves or analogized on/off valves are preferred.

The system is favorably controlled by an electronic control unit, for example by a conventional microcontroller system or a system of digital signal processors. To provide the driver with a direct actuating travel allocation after a change of the actuating force, the correlation between actuating force and actuating travel, e.g. in the kilohertz range, is quickly adapted. This adaptation is reached by a corresponding actuation of the first and/or second valve by way of the electronic control unit. When the driver applies force to the actuating unit, the volume in the simulator chamber is adjusted by an appropriate valve actuation of the first and/or second valve in such a manner that the desired correlation between actuating force and actuating travel is established for the driver. As this occurs, non-linearities between actuating force and actuating travel can also be illustrated. A reproduction of friction effects is likewise possible.

According to the present invention, a device for determining an actuating force applied by the driver to the actuating unit and an electronic control unit is associated with the actuating travel simulator, said electronic control unit controlling the adjusting means according to the actuating force determined. The actuating force which the driver applies to the actuating unit is e.g. sensed by at least one pressure sensor associated with the simulator chamber and/or a force sensor or travel sensor arranged at the actuating unit, and a pressure is adjusted in the simulator chamber that corresponds to the sensed pressure and/or sensed force.

The present invention arranges for the actuating travel simulator to be associated with a vehicle brake system, including wheel brakes that can be acted upon by pressure from the pressure source and are connectable to the hydraulic simulator chamber by at least one hydraulic connection closable by means of a separating valve. This renders the actuating travel simulator of the invention especially apt for electro-hydraulic brake systems (EHB).

Electro-hydraulic brake systems known in the art basically comprise a master cylinder and at least one independent pressure source, e.g. a motor-and-pump unit with a high-pressure accumulator, that is actuatable by a control unit and the pressure of which is applicable to wheel brakes of the vehicle. These brake systems further include a device for detecting the driver's deceleration wish and at least one valve associated with the independent pressure source, said valve permitting adjustment of the pressure generated by the pump according to the driver's braking wish.

The wheel brakes of prior-art EHB systems are connectable to the master cylinder by means of at least one hydraulic connection closable by means of a separating valve in order to operate the wheel brakes by muscular power of the driver if the independent pressure source fails. The master cylinder will then act as an emergency braking pressure generator (hydraulic through grip).

It is in the sense of the present invention that the actuating travel simulator of the invention in this system replaces the master cylinder of the brake system. The fluid is returned from the pressure source of the EHB into the hydraulic cylinder of the actuating travel simulator according to the invention for the purpose of adjusting the desired actuating travel characteristic curve. Thus, according to the invention, the actuating travel simulator assumes the actual function of the simulator (impressing a defined force-travel characteristic curve) and, in addition, the function of the master cylinder as emergency braking pressure generator for the EHB system.

The object is furthermore achieved in that in a process for adjusting a defined force-travel characteristic curve of an actuating unit for a vehicle brake system, in particular an automotive vehicle brake system, by means of an actuating travel simulator having a hydraulic simulator piston that is slidable by way of an actuation of the actuating unit and is arranged in a hydraulic simulator chamber containing a hydraulic fluid, the force-travel characteristic curve of the actuating unit is achieved by a controlled discharge or supply of hydraulic fluid out of the chamber or into the chamber.

The process is based on the fact that for example when a brake pedal is applied, which is in operative connection to the simulator piston by means of an adjusting means, e.g. a rod, said simulator piston is displaced in the simulator chamber, with the result that fluid volume is displaced directly out of the simulator chamber and that this direct displacement of fluid out of the simulator chamber is controlled by appropriate adjusting means so that a desired, predetermined force-travel curve is achieved. When the brake pedal is released again in this case, a supply of fluid into the simulator chamber is controlled in a similar fashion. Basically, the force-travel characteristic curve of the actuating unit is thus adjusted in dependence on a fluid volume directly displaced out of the simulator chamber.

### BRIEF DESCRIPTION OF THE DRAWINGS

The FIGURE shows a schematic view of an embodiment of the invention simulator for an electro-hydraulic brake (EHB).

### DETAILED DESCRIPTION OF THE PREFERRED EMBODIMENTS

Said brake system is principally configured like an EHB known in prior art, wherein the simulator of the invention (with associated valves and hydraulic connections) was substituted for the master cylinder and the simulator.

When force is applied to a brake pedal 1, simulator piston 4 is displaced in simulator chamber 3 of simulator 2. Actuation of first valve 5 (pressure reduction valve) causes discharge of pressure from the simulator chamber 3 and outlet of fluid volume from simulator chamber 3 by way of the first line 7 into the fluid supply reservoir 9. When the actuating force is reduced, a second valve 6 (pressure increase valve) is actuated to cause fluid volume out of pressure accumulator 10 to return into the simulator chamber 3 by way of a second line 8. The valves 5, 6 are controlled by an electronic control unit 13 (dotted paths in the FIGURE) on command of signals of an actuating travel sensor 11 and a pressure sensor 12 (dotted paths in the FIGURE). The actuating travel sensor 11 permits direct measurement of a deviation. Thus, the electronic control unit 13 may directly adjust the actuation by control in order to reach a defined nominal fluid volume in the simulator chamber 3. The connection to the wheel brakes can be isolated by means of a separating valve 14 in a hydraulic line 15. The separating valve 14 is favorably a normally open valve in order to ensure an emergency brake function with the help of the driver's foot force if the auxiliary energy source fails. The simulator 2 acts like a prior art master cylinder as an emergency braking pressure generator in this special case of operation.

During a normal service brake function of the EHB, the separating valve 14 is closed and the simulator 2 fulfils the per se known simulator functions for the EHB system. The details of the hydraulic circuit (on the left side of the dash-dot line A) and mode of operation of an EHB are sufficiently known to the expert in the art and are not illustrated herein in detail.

The correlation between actuating force and actuating travel is variable depending on the situation. This is appropriate to signal defined system conditions to the driver. If, for example, an air volume has been detected in an electro-hydraulic brake system, this can be signaled to the driver in the allocation of actuating force and actuating travel. This implies that a reproduction of the actuating travel behavior ‘air in the brake system’ is simulated, and the actuating travel behavior can be reproduced to comply with the behavior of a known hydraulic brake system, or it can be weakened or amplified compared to this known behavior.

The prior art mechanical or hydraulic/mechanical simulator can be replaced by means of the present invention by assuring the driver's braking wish, e.g. by way of the actuating force, and by controlling the pressure of the fluid in the simulator chamber 3 according to the driver's braking wish in such a manner that an actuating travel associated with the actuating force of the driver is adjusted and a defined force-travel characteristic curve is impressed on the actuating unit 1.

To sum up, the present invention has the following advantages:

Because the feedback to the driver is adjusted directly by the electronic control unit 13, the driver is able to monitor the function of the system. This is because malfunctions of the sensor system lead to a wrong allocation of force to travel.

Friction within the actuation is uncritical because the relatively high energy of a high-pressure accumulator 10 along with the actuation by way of e.g. analog valves will overcome this friction.

The behavior of the simulator 2 is easily variable by way of parameters within a software program of the electronic control unit 13. Therefore, reproducibility and a free design of the force-travel characteristic curves or a situation-responsive change are easily possible. The system of the invention is superior to the mechanical systems in terms of this flexibility.

The mounting space required for simulator 2 is smaller than the mounting space for a mechanical simulator with a spring. The invention simulator principally does not claim any mounting space in the driver's leg room in the vehicle.

A hydraulic throttling between the simulator chamber 3 and the valves 5, 6 can be compensated in the invention by means of the high energy available.

A volume displacement out of the simulator chamber 3 into the fluid supply reservoir 9 or the pressure accumulator 10 is not possible upon failure of the current supply because the (NC) valves 5, 6 are closed. In the hydraulic fallback level of an EHB system, the volume of the simulator chamber 3 is therefore fully available for braking without needing travel-responsive valves in the simulator chamber for this purpose.

### List Of Reference Numerals

1 actuating pedal

2 simulator

3 simulator chamber

4 simulator piston

5 first valve

6 second valve

7 first line

8 second line

9 fluid supply reservoir

10 pressure source

11 travel sensor

12 pressure sensor

13 control unit

14 separating valve

15 hydraulic line

1. Actuating travel simulator for a vehicle actuating unit, preferably a brake pedal, which simulator includes a hydraulic simulator piston in a hydraulic simulator chamber containing a hydraulic fluid,
characterized in that said simulator chamber includes at least one opening through which fluid is discharged from or supplied to the simulator chamber when the vehicle actuating unit is actuated, and that an adjusting means is provided to control the fluid volume discharged from the simulator chamber and/or supplied to the simulator chamber in such a way that a defined force-travel characteristic curve of the actuating unit is produced.

2. Actuating travel simulator as claimed in claim 1,
characterized in that associated with the actuating travel simulator is a preferably non-pressurized supply reservoir for the hydraulic fluid, said reservoir being connected to the simulator chamber by way of a first hydraulic line in which a first adjusting means, preferably a first valve, is arranged.

3. Actuating travel simulator as claimed in claim 1 or 2,
characterized in that a pressure source for the hydraulic fluid, preferably a high-pressure accumulator, is associated with the actuating travel simulator, said pressure source being connected to the simulator chamber by way of a second hydraulic line in which a second adjusting means, preferably a second valve, is arranged.

4. Actuating travel simulator as claimed in any one of claims 1 to 3,
characterized in that the first and/or the second valve is a normally closed (NC) valve, preferably an analog valve or an analogized on/off valve.

5. Actuating travel simulator as claimed in any one of claims 1 to 4,
characterized in that a device for determining an actuating force applied by the driver to the actuating unit and an electronic control unit is associated with the actuating travel simulator, said electronic control unit controlling the adjusting means according to the actuating force determined.

6. Actuating travel simulator as claimed in any one of claims 1 to 5,
characterized in that the actuating travel simulator is associated with a vehicle brake system, including wheel brakes that can be acted upon by pressure from the pressure source and are connectable to the hydraulic simulator chamber by at least one hydraulic connection closable by means of a separating valve.

7. Process for adjusting a defined force-travel characteristic curve of an actuating unit for a vehicle brake system by means of an actuating travel simulator having a hydraulic simulator piston that is slidable by way of an actuation of the actuating unit and is arranged in a hydraulic simulator chamber containing a hydraulic fluid,
characterized in that the force-travel characteristic curve of the actuating unit is adjusted by a controlled discharge or supply of hydraulic fluid out of the chamber or into the chamber.

8. Actuating travel simulator as claimed in any one of claims 1 to 6 or process as claimed in claim 7,
characterized in that the actuating travel simulator or the process is used for adjusting a defined force-travel characteristic curve of an automotive vehicle brake pedal.

9. Actuating travel simulator or process as claimed in any one of claims 1 to 8,
characterized in that the actuating travel simulator fulfils the function of an emergency braking pressure generator.
